(19) United States
(12) Patent Application Publication
(10) Pub. No.: US 2023/0194164 A1
(43) Pub. Date: Jun. 22, 2023

(54) DEVICE FOR REMOVING RAINWATER FROM UMBRELLA

(71) Applicant: Kyoung Youl LEE, Seoul (KR)

(72) Inventor: Kyoung Youl LEE, Seoul (KR)

(21) Appl. No.: 17/906,337

(22) PCT Filed: May 14, 2021
(86) PCT No.: PCT/KR2021/006047

§ 371 Date: Sep. 14, 2022

(30) Foreign Application Priority Data
May 14, 2020 (KR) 10-2020-0057459
May 14, 2020 (KR) 10-2020-0057470
May 14, 2020 (KR) 10-2020-0057473
May 14, 2020 (KR) 10-2020-0057477

(51) Int. Cl. F26B 5/02; F26B 9/00; A47G 25/12

(52) U.S. Cl. CPC F26B 5/02; F26B 9/003; A47G 25/12; F26B 2210/10

(57) ABSTRACT

A device for removing rainwater from an umbrella is disclosed. The device for removing rainwater from an umbrella comprises: a stand extending upward from a support; a holder for fixing an umbrella shaft; a driving apparatus coupled to the stand and for vibrating the holder; and a processor for controlling the vibration generated by the driving apparatus. The holder comprises: an opening; a fixing groove for fixing the umbrella shaft; and a support member for supporting the umbrella shaft from the opening to the fixing groove. The opening is open in the linear direction to the fixing groove such that the umbrella shaft is inserted in one direction from the opening to the fixing groove.

### TECHNICAL FIELD

This disclosure relates to a device for removing rainwater from an umbrella, and to a device capable of removing rainwater from an umbrella by fixing and vibrating an umbrella shaft.

### BACKGROUND ART

If rainwater remaining on a canopy is not properly removed after using an umbrella, rainwater may fall on the floor and may cause difficulties in storage. Furthermore, an umbrella shaft and umbrella ribs are mainly made of metal, and corrosion due to rainwater may occur. Therefore, in order to remove rainwater remaining in the canopy of the umbrella, the rainwater needs to be effectively removed through a device for removing rainwater from an umbrella in addition to wiping or brushing umbrella.

In the related art, in order to remove rainwater from an umbrella, rainwater may be removed by putting the umbrella in a device with the umbrella folded and shaking the umbrella or using strong wind, but the rainwater cannot be properly removed from the inside of the canopy, or the industrial applicability is not high due to the problem of volume and cost and thus, there is a necessity of a device for removing rainwater from an umbrella that may remove the rainwater of the umbrella quickly and efficiently.

### DISCLOSURE

### Technical Problem

It is an object of the disclosure to address the above-mentioned problems, and provide a device capable of removing rainwater from an umbrella by fixing and vibrating the umbrella shaft.

### Technical Solution

A device for removing rainwater from an umbrella according to an embodiment includes a stand extending upward from the support; a holder for fixing an umbrella shaft; a driving apparatus coupled to the stand and for vibrating the holder; a processor for controlling vibration generated by the driving apparatus, and the holder includes an opening, a fixing groove for fixing the umbrella shaft, and a support member for supporting the umbrella shaft from the opening to the fixing groove, width of the opening decreases at a predetermined interval in the fixing groove direction from an outside of the holder, and the opening is open in a linear direction to the fixing groove such that the umbrella shaft is fixed to the support member or the fixing groove matching the width of the umbrella shaft.

The opening may be opened toward a side of the holder, the fixing groove may be formed below the opening, and the support member may have a direction of being inclined in a downward direction of the holder.

The opening may be opened toward an upper portion of the holder, and the driving apparatus may generate vibration of left and right directions to the holder.

The width of the opening may gradually decrease from the outside of the holder toward the fixing groove direction.

The stand may be inclined toward a front direction from the stand.

The device may further include a coupling member disposed between the holder and the driving apparatus, and the coupling member may support the holder by a holder spring.

The holder may include a plurality of openings and the fixing grooves, and the plurality of fixing grooves may have different widths.

The device may further include a switch disposed between the fixing groove and the opening, and the switch may selectively apply power to a processor according to whether an umbrella shaft is mounted to the holder.

The device may further include a first detection sensor for detecting a canopy of the umbrella shaft coupled to the holder.

The device may further include a second detection sensor located below the first detection sensor and for detecting distance from the canopy of the umbrella shaft coupled to the holder.

### Effect of Invention

A device for removing rainwater from an umbrella according to various embodiments of the disclosure may effectively remove rainwater of an umbrella by using a holder and a driving apparatus that causes vibration.

### DESCRIPTION OF DRAWINGS

FIG. 1 is a diagram illustrating a device for removing rainwater according to an embodiment of the disclosure;

FIG. 2 is a diagram illustrating a holder according to an embodiment of the disclosure;

FIG. 3 is a diagram illustrating a holder according to an embodiment of the disclosure;

FIG. 4 is a diagram illustrating a holder and a coupling member according to an embodiment of the disclosure;

FIG. 5 is a diagram illustrating a holder according to an embodiment of the disclosure;

FIG. 6 is a diagram illustrating a holder and a driving apparatus according to an embodiment of the disclosure;

FIG. 7 is a diagram illustrating a sealing according to an embodiment of the disclosure;

FIG. 8 is a diagram illustrating a detection sensor according to an embodiment of the disclosure;

FIGS. 9A and 9B are diagrams illustrating coupling of a device for removing rainwater and an umbrella according to an embodiment of the disclosure;

FIG. 10 is a diagram illustrating a bottom surface of a support according to an embodiment of the disclosure;

FIG. 11 is a diagram illustrating a display according to an embodiment of the disclosure;

FIG. 12 is a diagram illustrating an internal sensor and an internal light source of a holder according to an embodiment of the disclosure;

FIG. 13 is a diagram illustrating a safety cap of a holder according to an embodiment of the disclosure;

FIG. 14A is a diagram illustrating a holder according to an embodiment of the disclosure;

FIG. 14B is a diagram illustrating a guide portion of a holder according to an embodiment of the disclosure;

FIG. 15 is a diagram illustrating a holder according to an embodiment of the disclosure;

FIG. 16 is a diagram illustrating a holder including a latch according to an embodiment of the disclosure;

FIG. 17 is a diagram illustrating a holder including a leaf spring according to an embodiment of the disclosure;

FIG. 18 is a diagram illustrating a driving apparatus according to an embodiment of the disclosure;

FIG. 19 is a diagram illustrating a coupling member of a holder according to an embodiment of the disclosure;

FIG. 20 is a diagram illustrating a detachable holder according to an embodiment of the disclosure;

FIG. 21 is a diagram illustrating a switch of a holder according to an embodiment of the disclosure;

FIG. 22 is a diagram illustrating a holder according to an embodiment of the disclosure;

FIG. 23 is a diagram illustrating a holder according to an embodiment of the disclosure;

FIG. 24 is a diagram illustrating a holder according to an embodiment of the disclosure; and

FIG. 25 is a diagram illustrating a holder according to an embodiment of the disclosure.

### BEST MODE FOR CARRYING OUT THE INVENTION

-

### MODE FOR CARRYING OUT THE INVENTION

Hereinafter, the terms used in the present specification will be briefly described, and the disclosure will be described in detail.

The terms used in the disclosure and the claims are general terms identified in consideration of the functions of embodiments of the disclosure. However, these terms may vary depending on intention, legal or technical interpretation, emergence of new technologies, and the like of those skilled in the related art. In addition, in some cases, a term may be selected by the applicant, in which case the term will be described in detail in the description of the corresponding disclosure. Thus, the term used in this disclosure should be defined based on the meaning of term, not a simple name of the term, and the contents throughout this disclosure.

One or more specific embodiments of the disclosure are illustrated in the drawings and are described in detail in the detailed description. However, it is to be understood that the disclosure is not limited to the one or more specific embodiments, but includes all modifications, equivalents, and substitutions without departing from the scope and spirit of the disclosure. Also, well-known functions or constructions are not described in detail since they would obscure the disclosure with unnecessary detail.

It will be understood that, although the terms first, second, etc. may be used herein to describe various elements, these elements should not be limited by these terms. The terms are used only for the purpose of distinguishing one component from other components

A singular expression includes a plural expression, unless otherwise specified. It is to be understood that the terms such as “comprise” may, for example, be used to designate a presence of a characteristic, number, step, operation, element, component, or a combination thereof, and not to preclude a presence or a possibility of adding one or more of other characteristics, numbers, steps, operations, elements, components or a combination thereto.

Embodiments of the disclosure will be described in detail with reference to the accompanying drawings to aid in the understanding of those of ordinary skill in the art. However, the disclosure may be realized in various different forms and it should be noted that the disclosure is not limited to the various embodiments described herein. Further, in the drawings, parts not relevant to the description may be omitted, and like reference numerals may be used to indicate like elements.

The disclosure will be described in greater detail with reference to the attached drawings.

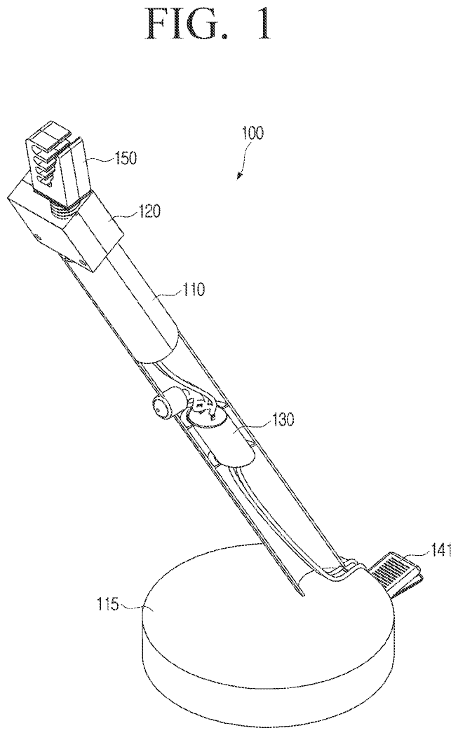

FIG. 1 is a diagram illustrating a device for removing rainwater according to an embodiment of the disclosure.

Referring to FIG. 1, a device for removing rainwater from an umbrella 100 may include a stand 110, a driving apparatus 120, a processor 130, and a holder 150.

The stand 110 may extend upward from the support 115, and there is no restriction on the shape or the extended height of the stand 110, but the vertical height from the support 115 may be within the range of motion of the user's hand when a user is in a standing state.

The stand 110 may be inclined from the support 115 from the support 115 and may extend upward. An umbrella has a structure in which a canopy made of fabrics such as waterproof cloth and nylon is combined on a skeleton composed of a handle, an umbrella shaft, and umbrella ribs, and when an umbrella is lifted up, umbrella ribs of an ordinary umbrella have a shape of being bent downward.

Therefore, as the stand 110 is inclined, when the umbrella shaft of the umbrella in the unfolded state is fixed to the holder 150, the unfolded canopy and the umbrella ribs may not touch the stand 110. As will be described later, since the driving apparatus 120 may vibrate the holder 150 to remove rainwater from the umbrella canopy, the position of the umbrella shaft fixed to the holder 150 may effectively vibrate the canopy as being closer to a tip of the umbrella. Therefore, assuming a situation in which the user fixes the umbrella shaft to the holder 150 in the vicinity of the support 115, the umbrella shaft fixed to the holder 150 is close to the end of the umbrella in a structure where the stand 110 is inclined, rather than in a structure where the stand 110 is vertically extended from the support 115, so vibration may be efficiently delivered to the canopy of the umbrella.

The angle at which the stand 110 is inclined is not limited, but in consideration of the above feature, in order to fix the umbrella shaft which is not in touch with the canopy of an umbrella and the stand 110 and close to the end of the umbrella to the holder 150, the internal angle from the support 115 may be formed to about 70 degrees.

The driving apparatus 120 may remove rainwater of the umbrella fixed to the holder 150 by adding vibration to the holder 150.

The driving apparatus 120 may remove rainwater by the force and inertia to shake the umbrella shaft using vibration. The method of removing rainwater using wind has a relatively high production cost, and rainwater may splash widely, so it was necessary to prepare a structure inside a device to drain the rainwater that fell separately, so there was a limitation in that the device is not appropriate to be disposed at an entrance due to heavy weight and large volume and storage and moving are not easy. Therefore, the driving apparatus 120 may be advantageous in practicality and convenience by using vibration.

The driving apparatus 120 may be coupled to the upper end of the stand 110 and connected to the holder 150 above. The direction in which the driving apparatus 120 vibrates the holder 150 may be up and down or left and right, and the umbrella fixed to the holder 150 may remove rainwater from the canopy by inertia as the vibration occurs.

The processor 130 may control the vibration generation of the driving apparatus 120. There is no limitation on the position and control method of the processor 130, and the processor 130 may control the driving apparatus 120 by supplying and cutting off power.

The processor 130 and the driving apparatus 120 may be supplied with power by a battery 125 inside the device for removing rainwater from the umbrella 100, or may be supplied with power from the outside of the device for removing rainwater from the umbrella 100. The device for removing rainwater from the umbrella 100 is mainly disposed at an entrance for entering indoor space at rainy days, it may be advantageous to select the position of the device for removing rainwater from the umbrella 100 when power is supplied by the internal battery 125, and it is possible to prevent safety problems that may occur when rainwater or the like flows into the external power supply.

The holder 150 may fix the umbrella shaft. The device for removing rainwater from an umbrella 100 may fix the umbrella shaft of the umbrella of which canopy is unfolded by the holder 150.

In a state in which the umbrella is folded, that is, when the canopy of the umbrella is folded by the umbrella ribs, folded portions of the canopy may be disadvantageous for the removal of rainwater. Therefore, the device for removing rainwater from the umbrella 100 according to the disclosure may be used in a state where the umbrella is unfolded so as to be advantageous for removing rainwater, and accordingly, the holder 150 may fix the umbrella ribs in a state in which the umbrella is unfolded.

The holder 150 may vary in addition to the embodiment illustrated in FIG. 1, and the shape and size and material of the holder 150 may have no limitation. Hereinafter, various embodiments of a holder that may be included in the device for removing rainwater from the umbrella 100 will be described in detail.

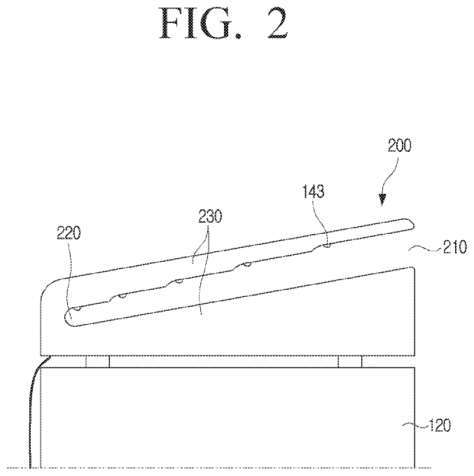

FIG. 2 is a diagram illustrating the holder 200 according to an embodiment of the disclosure.

Referring to FIG. 2, the holder 200 may include an opening 210, a fixing groove 220, and a support member 230, and may be made of a light material such as an aluminum alloy.

The opening 210 is a space opened to one side of the holder 200, and is an entry path through which the umbrella shaft enters the holder 200. The umbrella shaft input through the opening 210 may move toward the direction of the fixing groove 220.

The shape and direction of the opening 210 may be diverse and may be formed at a left side or a right side of the holder 200 as illustrated in FIG. 2 and may continue to the fixing groove 220.

The opening 210 may be opened in a straight direction to the fixing groove 220. The umbrella shaft input to the opening 210 may be input in one direction from the opening 210 to the fixing groove 220.

The user may fix the umbrella shaft to the holder 200 by only an action of putting the umbrella shaft in one direction on the opening 210, and furthermore, in an embodiment including the opening 210 of which the width decreases and the inclined support member 230, the umbrella shaft may be fixed at an appropriate position without being restricted to the size and the entry path of the umbrella shaft.

The fixing groove 220 may fix the umbrella shaft, and an ordinary shape of an umbrella shaft is circular, the end portion of the fixing groove 220 may be formed to be semi-circular.

The support member 230 may support the umbrella shaft from the opening 210 to the fixing groove 220, and the umbrella shaft inserted into the holder 200 through the opening 210 may not be separated to the outside through the support member 230 and may be induced to the fixing groove 220.

The support member 230 may be a portion of a vicinity in which the opening 210 is formed in the holder 200. Alternatively, although not shown in the drawings, the support member 230 may include a support configuration capable of supporting an umbrella shaft such as a support plate, a support bar, and the like, and reducing the loss of vibration.

The support member 230 may be made of a material identical with the material of the holder 200 or a material having stiffness or elasticity in consideration of durability and fixedness.

The opening 210 may be opened to the side of the holder 200, and the fixing groove 220 may be formed lower than the opening 210. Accordingly, the support member 230 surrounding and connecting the fixing groove 220 and the opening 210 may have a direction inclined toward the lower end of the holder 200. In this case, the angle at which the support member 230 is inclined may be approximately 10 degrees downward with respect to the horizontal of the support.

In this example, when the user places the umbrella shaft in the opening 200, the umbrella shaft may fall or slid toward the lower direction of the holder 200 in which the fixing groove 220 is formed, so even if the user does not fix the umbrella shaft to the proper position of the holder 200 separately, the umbrella shaft may be fixed.

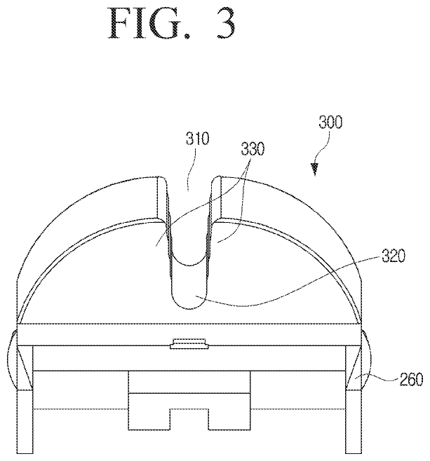

FIG. 3 is a view illustrating the holder 300 according to an embodiment of the disclosure, and the holder 300 may be made of a material having soft and high rigidity, such as a functional plastic.

Referring to FIG. 3, the opening 310 may be opened to an upper end of the holder 300. The umbrella shaft is directly dropped into a fixing groove 320 formed at a lower end in one direction through the opening 310 opened toward the upper end. Accordingly, the umbrella shaft may directly reach the fixing groove 320, and may be fixed to the fixing groove 230 by gravity.

The driving apparatus 120 may generate vibration in the left and right directions in the holder 300. The support member 330 may prevent the umbrella shaft from being separated from the left side and the right side of the opening 310 by the open opening 310 opened toward the upper end, thereby preventing the loss of vibration by fixing the umbrella shaft.

The width of the opening 310 may gradually decrease from the outside of the holder 300 toward the fixing groove 320. As the width of the opening 310 decreases, the umbrella shaft may be fixed to the support member 430 without reaching the fixing groove 320. Therefore, the holder 300 including one opening 310 and one fixing groove 320 may fix the umbrella shaft of various sizes, and when the umbrella shaft is put into the opening 310, the umbrella shaft may move to the lower end and may be fixed to the opening 310 or the fixing groove 320 having an appropriate width.

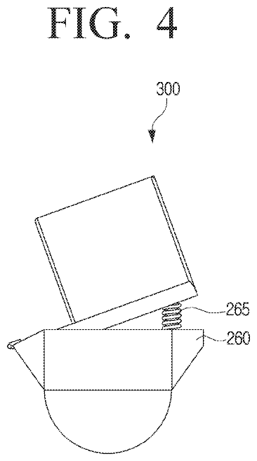

FIG. 4 is a diagram illustrating a holder 300 and a coupling member 260 according to an embodiment of the disclosure.

Referring to FIG. 4, the device for removing rainwater from the umbrella 100 may further include a coupling member disposed between the holder 300 and the driving apparatus 120, and the coupling member may support the holder with a holder spring 265.

The coupling member 260 may couple the holder 300 and the driving apparatus 120 and may vibrate by the driving apparatus 120 together with the holder 300.

The coupling member 260 may include a holder spring 265, and the holder spring 265 may support only a portion of the lower surface of the holder 300. As shown in FIG. 4, a portion of the holder 300 may be fixed to the coupling member 260, and a portion of the holder 300 may be connected to the holder spring 265.

The holder spring 265 may support the holder 300 such that the holder 300 is inclined upward, and a rotation shaft may be formed on a surface of the holder 300 fixed to the coupling member 260, so that the holder 300 may secure flexibility around the rotation axis. In addition, the coupling spring 265 may minimize energy loss when the vibration of the driving apparatus 120 is transmitted to the holder 300.

Since the stand 110 may be tilted forward from the support 115, the holder 300 may be tilted by the coupling member 260 and coupled. In this case, the angle at which the stand 110 is inclined may be about 70 degrees, and the angle at which the holder 300 is inclined may be about 20 degrees.

The opening 310 of the holder 300 may be horizontal or slightly inclined with respect to the support 115 with respect to the user to easily insert the umbrella shaft into the holder 300, thereby user convenience may be improved.

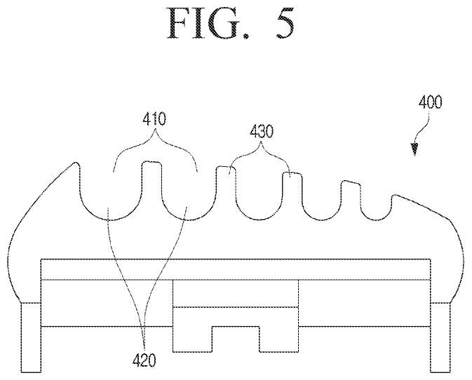

FIG. 5 is a diagram illustrating a holder 400 according to an embodiment of the disclosure.

Referring to FIG. 5, the holder 400 may include a plurality of openings 410 and fixing grooves 420, and each of the plurality of fixing grooves 420 may have different widths.

The plurality of openings 410 may be opened in the same direction of the holder 400, and may be opened in a straight line direction by the plurality of fixing grooves 420, respectively. The plurality of fixing grooves 420 may have different widths and may fix the umbrella shaft having various widths.

The plurality of openings 410 may have the same width as the plurality of fixing grooves 420, and the support member 430 may have a linear shape. Accordingly, the most appropriate fixing groove 420 may be checked, and the umbrella shaft may be inserted by visually checking the width of the opening 410 of the holder 400, or fixing the umbrella shaft.

In an embodiment in which the width of the opening 410 is reduced, when the umbrella shaft is strongly input, the umbrella shaft may be caught in or damaged by the fixing groove 310, and when used for a long time, the opening 410 may be worn and the width of the opening 410 may not be constant. Therefore, a user may directly find and select an appropriate fixing groove 410 for fixing an umbrella shaft by the holder 400 including the opening 410 and the fixing groove 410.

As shown in FIG. 5, by disposing the fixing groove 410 of which the upper portion of the holder 400 has a circular arc shape, and the width of the plurality of fixing grooves 410 is reduced or increased in one direction, the user may select an appropriate fixing groove 410 for inserting the umbrella shaft by placing the umbrella shaft on one side and moving the umbrella shaft to the left or the right.

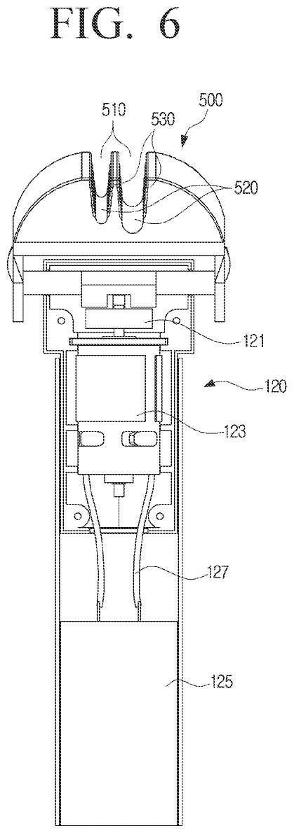

FIG. 6 is a diagram illustrating a holder 500 and a driving apparatus 120 according to an embodiment of the disclosure.

Referring to FIG. 6, a plurality of openings of the holder 500 may have a decreasing width from the outside of the holder 500 toward the fixing groove 520.

When two to three openings 510 are present in the plurality of openings 510, the plurality of openings 510 may distinguish between a large umbrella and a small umbrella, thereby securing convenience and versatility at the same time, as an ordinary umbrella is divided into a small umbrella for portability and a large umbrella for functionality.

The driving apparatus 120 may be applied in various methods to add vibration to the holder 500 and may include a battery 125, wire 127, motor 123, and gear 121.

The battery 125 may supply power to the motor 123 through the electric wire 127. Since the device for removing rainwater from the umbrella 100 is mainly disposed at the entrance of a building or the like at the time of raining, a cable connection for receiving external power is not required by adopting the format of the battery 125, the flexibility of the arrangement position is secured, and the risk of electric shock when exposed to rainwater may be reduced.

The motor 123 may generate vibration in the holder 500 attached to the upper portion using the gear 121. A vibration displacement and a vibration period of the holder 500 may be determined by a coupling method and a shape of the gear 121.

Since rainwater is removed with inertia force caused by the vibration of the holder 500, a method of rapidly generating vibration at a small displacement may be advantageous to quickly remove rainwater. Therefore, the vibration displacement of the holder 500 may be 1 cm to 2 cm in consideration of the rainwater removal effect of the umbrella and the safety of the user.

Although not shown in the drawing, the holder 200 according to an embodiment may include a latch, and the latch may prevent separation of the umbrella shaft fixed to the holder 200.

The latch may have a structure and shape so that the latch is softly pressed in a direction in which the umbrella shaft is inserted through the opening 210.

One or a plurality of latches may be disposed on one support member. In addition, the latch may be fixed at the time of driving the driving apparatus by the processor 130 to completely prevent separation of the umbrella shaft.

The coupling position and coupling angle of the umbrella shaft may be different for each user, so the coupling of the holder 200 and the umbrella shaft may be easier by flexibility of the holder 200.

The holder 200 is detachable. An inlet may be included in the lower end of the coupling member and the inlet may be separated so that the holder 200 is detachably connected to the device for removing rainwater from an umbrella 100.

The holder 200 may be damaged or worn by vibration or may need to change the shape of the holder 200 according to circumstances. The holder 200 may include an inlet, so that the holder 200 may be changed by the user, the repair of the holder 200 may be facilitated, and the user may reduce maintenance costs.

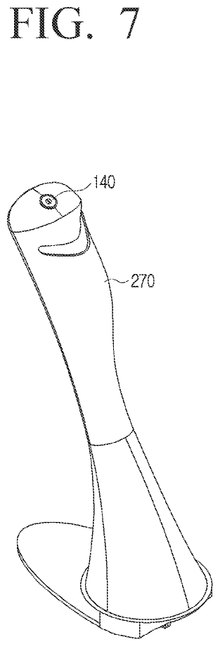

FIG. 7 is a diagram illustrating a sealing according to an embodiment of the disclosure.

Referring to FIG. 7, the holder sealing (not shown) may surround the outside of the holder 200, or the sealing 270 may surround the overall potion including the driving apparatus 120 and the stand 110.

For reference, the sealing 270 of FIG. 7 opens only one opening 210 of the holder 200, but is not limited thereto, and may have various shapes by reflecting the structure of the holder 200.

Rainwater or a foreign material may enter or be inserted to a coupling portion between the driving apparatus 120 and the holder 200 by the entering of the umbrella shaft. The inflow of rainwater and foreign material may be a cause of a failure of a driving unit, and when a foreign material is caught, it is possible to reduce the efficiency of rainwater removal by interrupting vibration.

Therefore, the holder sealing (not shown) may be in close contact with the holder 400 and may move together with the holder 200 during driving, so that the holder 200 and the lower portion may be surrounded, thereby increasing durability and energy efficiency. The holder sealing (not shown) may be made of a material having a waterproof effect and a low risk of being damaged by vibration, and may be, for example, silicon.

The sealing 270 may surround and protect the holder 200, the stand 110, and the driving apparatus 120 together. In this case, only the periphery of the opening 210 of the holder 200 through which the umbrella shaft moves may be exposed to the outside, so that an overall part of the device for removing rainwater from an umbrella 100 including the driving apparatus 120 and the stand 110 may be protected from rainwater and foreign materials. In addition, a holder sealing (not shown) surrounding the outside of the holder 200 and a sealing 270 surrounding the stand 110 and the driving apparatus 120 may be present together.

The device for removing rainwater from an umbrella 100 may include the switch 140 for selectively applying power to the processor 130 by an input signal. The format and position of the switch 140 have no limitation and an embodiment of the switch 140 is described below.

The switch as a button type switch 140 as illustrated in FIG. 7 may be attached to the sealing 270, and in this case, power may be applied by user's manipulation. The button type switch 140 has an advantage of being intuitive and easy to operate, but it is cumbersome to press the switch 140 every time. Alternatively, when the button of the switch 140 is pressed once, the power may be set to be applied to the processor 130 for a specified time, for example, 5 seconds to 10 seconds.

The switch may be formed in the form of a pedal 141 as illustrated in FIG. 1, and when the pedal 141 is pressed, power may be applied to the processor 130, and when pressure is removed from the pedal 141, power may be blocked to the processor 130. In addition to the advantage of being intuitive and easy to manipulate, the pedal 141 is advantageous in that the pedal 141 may be easily operated by foot when both hands of a user may not be free or in an emergent situation. It may be set such that power is applied only while a physical pressure is applied to the pedal 141, or the power may be applied to the processor 130 only by a time designated as one physical pressure application.

As shown in FIG. 2, the holder 200 may include a holder switch 143. The holder switch may be formed between the opening 210 and the fixing groove 220 to selectively apply the power to the processor 130 according to whether the holder 200 is mounted in the umbrella shaft.

The holder switch 143 may be switched by the umbrella shaft when the umbrella shaft enters through the opening 210, and may apply power to the processor 130. The holder switch 143 may drive the driving apparatus 120 by automatically applying power to the processor 130 without any operation other than the basic operation for fixing the umbrella shaft, thereby increasing user convenience.

The holder switch 143 may allow the processor 130 to recognize the specific support member 230 in which the umbrella is fixed among the support members 230, thereby differently controlling the vibration method.

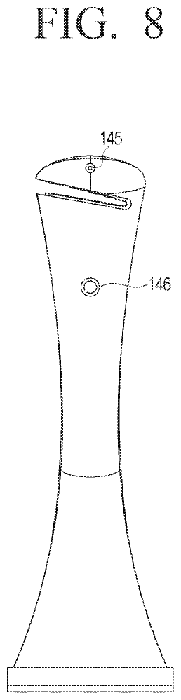

FIG. 8 is a diagram illustrating a detection sensor according to an embodiment of the disclosure.

Referring to FIG. 8, the detection sensors 145, 146 may detect the holder 200 and the canopy of the umbrella shaft coupled to the holder 200 and may provide the detection result to the processor 130.

The detection sensors 145 and 146 may detect a canopy of an unfolded umbrella fixed to the holder 200. In this case, the detection sensors 145 and 146 may sense whether the umbrella shaft is coupled, such as a role of a switch, to apply power or provide a detection result to the processor 130.

The device for removing rainwater from an umbrella 100 may include two or more detection sensors 145 and 146, and may include a first detection sensor 145 and a second detection sensor 146 that senses a canopy coupled with the umbrella shaft together with the first detection sensor 145 and may provide a detection result to the processor 130.

A shape of unfolded canopy of the umbrella shaft may be more accurately sensed through the second detection sensor 146, and the distance between the holder 200 and the canopy of the umbrella shaft may be detected. The second detection sensor 146 may increase the accuracy of the first detection sensor 145 and may improve the performance of the switch or the safety sensor.

The detection sensors 145 and 146 may be safety sensors for preventing accidents. Since the device for removing rainwater from an umbrella 100 of the disclosure forcibly vibrates the holder 200, safety problems such as when a body part such as a finger is caught in the holder 200 or other objects are attached and blown may occur.

Therefore, even when power is applied by the switch 140, the detection sensors 145 and 146 may detect whether there is a canopy of the unfolded umbrella, and if there is a fixed object but the canopy of the umbrella is not detected, the processor 130 may turn power off. Alternatively, even when the umbrella shaft is unfastened or removed during operation, when the canopy is not detected by the detection sensors 145 and 146, the driving may be immediately stopped to prevent an accident from detachment.

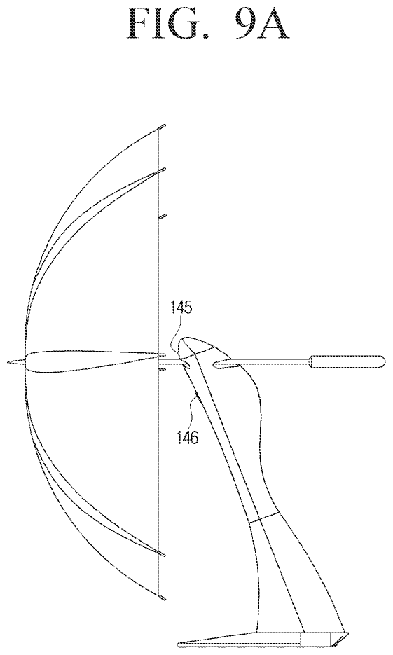

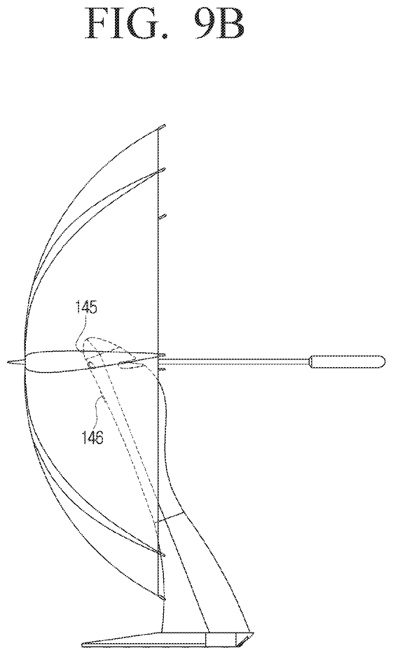

FIGS. 9A and 9B are diagrams illustrating coupling of a device for removing rainwater and an umbrella according to an embodiment of the disclosure.

Referring to FIGS. 9A and 9B, the first detection sensor 145 and the second detection sensor 146 may improve the rainwater removal performance of the device for removing rainwater from an umbrella 100.

Since the umbrella ribs of a general umbrella have a shape that curves downward when the umbrella is lifted, or when the stand 110 is inclined from the support 115 instead of being vertical from the support 115 according to an embodiment of the disclosure, the distance to the canopy detected by the first detection sensor 145 and the second detection sensor 146 may be different.

However, since the disclosure applies vibration directly to the umbrella shaft, the vibration transmitted to the canopy may be different depending on the vibration displacement and the distance between the fixing part of the umbrella shaft and the canopy. In particular, in the unfolded umbrella, the center of gravity is located on the upper part of the umbrella where the umbrella ribs and the canopy exist.

In detail, the distance between the center of gravity of the unfolded umbrella and the fixing portion of the umbrella shaft gets closer as the distance between the canopy and the holder 200 increases as shown in FIG. 9B than when the distance between the canopy and the holder 200 is fixed relatively far as shown in FIG. 9A, and the vibration position and the canopy become closer, the energy by the vibration may be more effectively transferred to the canopy, and the rainwater remaining in the canopy may be removed.

The processor 130 may guide the appropriate fixing portion of the umbrella shaft as well as adjusting the intensity and displacement of the vibration according to the detection values of the first detection sensor 145 and the second detection sensor 146. The guidance method may use voice or the display 150 to be described later.

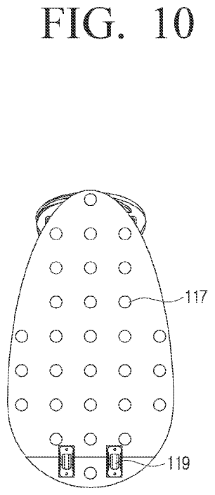

FIG. 10 is a diagram illustrating a bottom surface of a support 115 according to an embodiment of the disclosure.

Referring to FIG. 10, the support 115 may include an anti-slip member 117 attached to the bottom surface, and the device for removing rainwater from an umbrella 100 may include a castor 119 coupled to the support 115.

The device for removing rainwater from an umbrella 100 removes rainwater using inertia by vibration, and the vibration of the device needs to be minimized and the vibration should be effectively transmitted to the holder 200. The device for removing rainwater from an umbrella 100 is mainly disposed at an entrance of a building or the like only on rainy days, and thus it is necessary to easily store and move in order not to cause hindrance to entrance.

The anti-slip member 117 may be attached to the bottom surface of the support 115 so as to efficiently transfer the vibration to the umbrella, and at the same time, it is possible to prevent the risk of safety accidents when the device for removing rainwater from an umbrella 100 is driven at a slippery floor during rainy days. In addition, the caster 119 may be easily moved and stored.

The caster 119 may be one or at least two and may easily move the device for removing rainwater from an umbrella 100 by the caster 119. The caster 119 may be disposed on only one side of the support 115 and may tilt the stand 110 to move to the caster 119. As described above, since the device for removing rainwater from an umbrella 100 is disposed at the entrance of a building only on the rainy days, the sliding prevention member 117 and the caster 119 can prevent slipping and secure mobility.

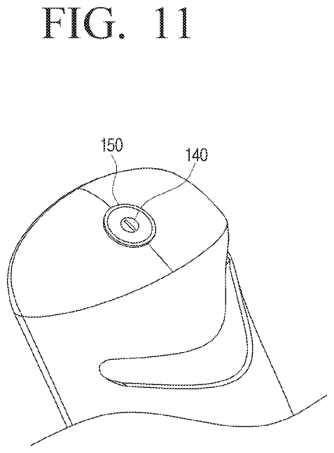

FIG. 11 is a diagram illustrating a display 150 according to an embodiment of the disclosure.

Referring to FIG. 11, the display 150 may display an operation state of the driving apparatus 120. The display 150 may surround the switch 140 and may be implemented in the form of an LED lighting on the front. In this case, the display 150 may display various states by changing colors.

For example, when power is not applied to the processor 130, no light flashes, a green light may be emitted in a standby state, and a yellow light is emitted in a ready state when the umbrella shaft is fixed and before starting operation, a red light is emitted while the driving apparatus 120 is driving, and a yellow light may be emitted again after the operation is finished again. Furthermore, when the battery 125 is insufficient, the light may be turned on with a cycle to notify the user.

Although not shown in the drawings, the display 150 may display a state and control operation in more detail through an image display device, in addition to a simple LED lighting type. In addition to the display 150, the user may be informed of the above-described operating state through sound.

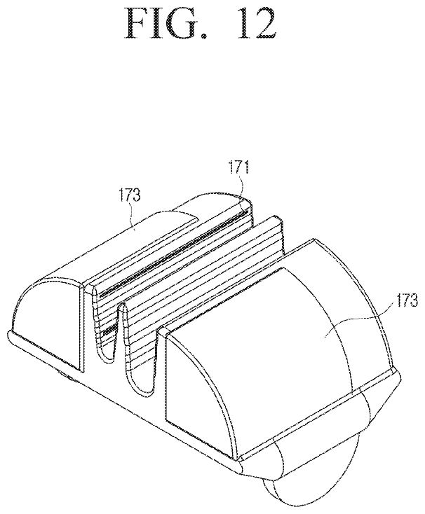

FIG. 12 is a diagram illustrating an internal sensor 173 and an internal light source 171 of the holder 200 according to an embodiment of the disclosure.

Referring to FIG. 12, an internal sensor 173 attached to the holder 200 performs detection in the direction of a grip of an umbrella which is a direction opposite to the direction in which the canopy is unfolded. While the device for removing rainwater from an umbrella 100 is driving, a user may be injured due to vibration of the holder 200 and the umbrella shaft, the internal sensor 173 is disposed in the direction of the handle where the user is located, and when the holder 200 is driven near the driving holder 200, a detection result may be sent to the processor 130, a warning signal may be sent through the display 150, or the operation of the driving apparatus 120 may be stopped.

The internal light source 171 may be attached to the position of the opening 210 of the holder 200 and may assist use of the device for removing rainwater from an umbrella 100 in a dark environment where visibility is not good.

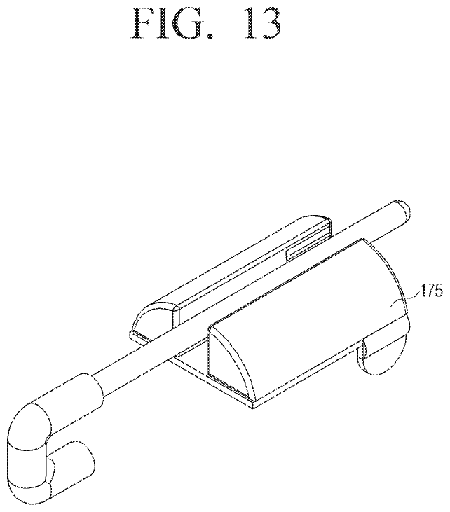

FIG. 13 is a diagram illustrating a safety cap 175 of the holder 200 according to an embodiment of the disclosure.

Referring to FIG. 13, since a safety accident may occur due to the vibration of the driving apparatus 120 as described above, the holder 200 may include a safety cap 175 and may prevent safety accident of being injured by the holder 200 in an economical way.

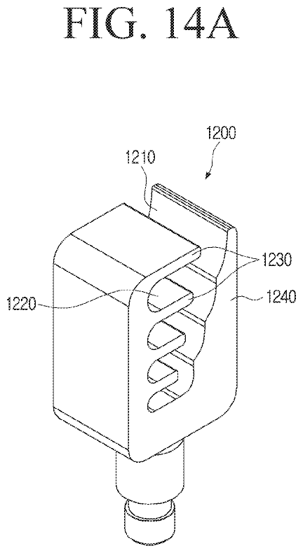

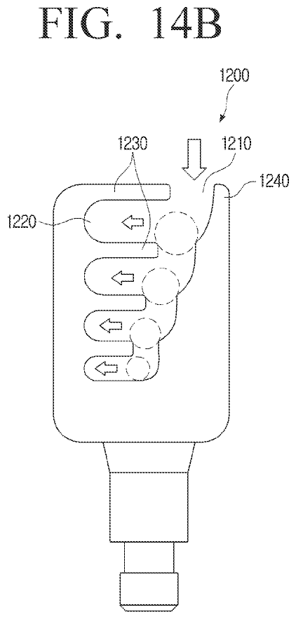

FIG. 14A is a diagram illustrating the holder 1200 according to an embodiment of the disclosure; and FIG. 14B is a diagram illustrating a guide portion of the holder 1200 according to an embodiment of the disclosure.

Referring to FIG. 14A, the holder 1200 may fix the umbrella shaft. By the holder 1200 according to the disclosure, the device for removing rainwater from an umbrella 100 may fix the umbrella shaft of the umbrella with the canopy unfolded.

In the state of folded the umbrella, that is, in the state in which the canopy of the umbrella is folded by the umbrella ribs, the folded part may be disadvantageous in removing rainwater. The device for removing rainwater from an umbrella 100 may be used in an open state of the umbrella, which is advantageous in removing rainwater, and thus the holder 1200 may fix the umbrella ribs in the open state of the umbrella.

The holder 1200 may include an opening 1210, a fixing groove 1220, an input path 1230, and a guide bar 1240, and may be made of a light material such as an aluminum alloy.

The opening 1210 is an entrance through which the umbrella shaft enters into the holder 1200, and may be formed in various directions of the holder 1200, and is formed in the upper part of the holder 1200 as shown in FIG. 1, so that the user may input the umbrella shaft to the holder 1200 by lifting up the umbrella shaft upward and putting down the umbrella shaft in a direction of gravity.

The fixing groove 1220 may fix the umbrella shaft, and since the shape of the general umbrella shaft is circular, the end of the fixing groove 1220 may be formed in a semicircular shape.

The input path 1230 has a structure that connects the opening 1210 and the fixing groove 1220, and is an entrance road through which the umbrella shaft entering the opening 1210 enters the holder 1200. The input path 1230 may be formed to be extremely short.

The input path 1230 may have a length longer than the width of the fixing groove 1220. The input path 1230 may prevent the umbrella shaft from being separated from the fixing groove 1220 to the opening 1210 when the holder 1200 vibrates. Therefore, the input path 1230 may be formed with a length of about 2 to 2.5 times the width of the fixing groove 1220 to which the umbrella shaft is fixed.

The holder 1200 may include a plurality of fixing grooves 1220 having different widths. Since the diameter of the umbrella shaft is different depending on umbrellas, the device for removing rainwater from an umbrella 100 according to an embodiment of the disclosure may include a plurality of fixing grooves 1220 having different widths, thus securing versatile application, and may be used to remove rainwater of various kinds of umbrella.

The method of arranging the plurality of fixing grooves 1220 may be performed in the vertical direction of the holder 1200 according to the width of the plurality of fixing grooves 1220. In an embodiment of FIG. 14A in which the opening 1210 is formed on the upper portion of the holder 1200 and the width of the fixing groove 1220 decreases toward the lower portion, the umbrella shaft may be input to the fixing groove 1220 of an intuitively appropriate width as the umbrella shaft is pushed to the side and then goes down in a gravity direction.

Referring to FIG. 14B, the holder 1200 may include a guide bar 1240 for guiding the umbrella shaft coming from the opening 1210 to the fixing groove 1220, and in the case of including the plurality of fixing grooves 1220, the guide bar 1240 may guide the umbrella shaft coming from the opening 1210 to one of the plurality of fixing grooves 1220. The guide bar 1240 may have a curved shape, and may guide the input umbrella shaft moving in the gravity direction to move in the left-right direction.

The width between the input path 1230 and the guide bar 1240 may decrease as it goes downward. In addition, the width between the input path 1230 and the guide bar 1240 may be smaller than the width of the fixing groove 1220 connected by the input path 1230. Accordingly, an umbrella shaft having a size that does not pass between the input path 1230 and the guide bar 1240 may be guided to the fixing groove 1220 of the corresponding input path 1230, and may intuitively fix the umbrella shaft to the fixing groove 1220 having an appropriate width.

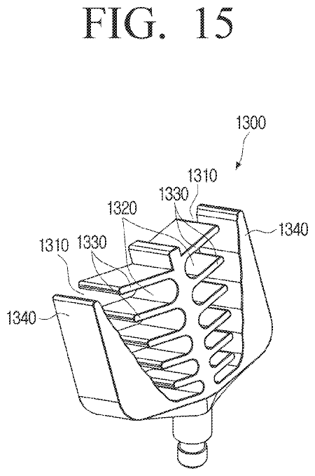

FIG. 15 is a diagram illustrating a holder 1300 according to an embodiment of the disclosure.

Referring to FIG. 15, the opening 1310 may include a left opening disposed on the left side and a right opening disposed at the right side of the holder, and the plurality of fixing grooves 1320 may be formed between the left opening and the right opening.

The energy loss of the vibration transmitted from the driving apparatus 1120 may occur when the overall height of the holder 1300 or height of the umbrella shaft fixed to the fixing groove 1320 becomes higher or moves away from the driving apparatus 1120. Therefore, when the fitting grooves 1320 having various widths are disposed, it is possible to prevent the height of the holder 1300 from being increased by dispersing the opening 1310 and the input path 1330 in the left and right directions.

The input path 1330 may have a direction inclined toward a lower end of the holder 1300. As the input path 1330 is inclined more effectively, when the holder 1300 vibrates more effectively, it is possible to prevent the umbrella shaft from being separated from the fixing groove 1320. Furthermore, as the umbrella shaft goes down to the lower end through the opening 1310 formed at the upper end of the holder 1300, and the intuitiveness and convenience may be improved to fix the umbrella shaft. The angle at which the input path 1330 is inclined may be about 10 degrees of an internal angle in the ground direction from the opening 1310.

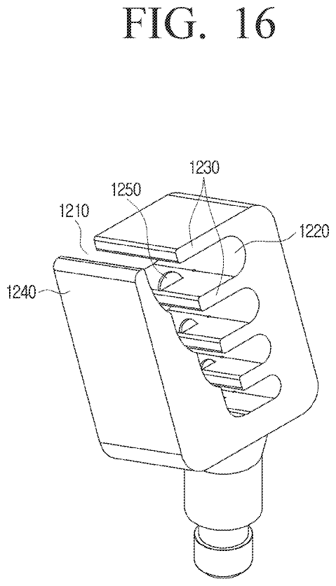

FIG. 16 is a diagram illustrating a holder 1200 including a latch 1250 according to an embodiment of the disclosure.

Referring to FIG. 16, the holder 1200 may include a latch 1250 disposed between the opening 1210 and the fitting groove 1220 to prevent separation of the umbrella shaft fixed to the fixing groove 1220.

The latch 1250 has a structure and a shape that may be smoothly pressed in a direction in which the umbrella shaft moves from the input path 1230, and may have a semicircular shape as shown in FIG. 16, but is not limited thereto, and may have a polygonal shape.

The latch 1250 may be disposed in each of the plurality of input paths 1230, and a plurality of latches 1250 may be disposed in one input path 1230. In addition, the latch 1250 may be fixed when the driving apparatus is driven by the processor 130, and thus, the detachment of the umbrella shaft may be prevented completely.

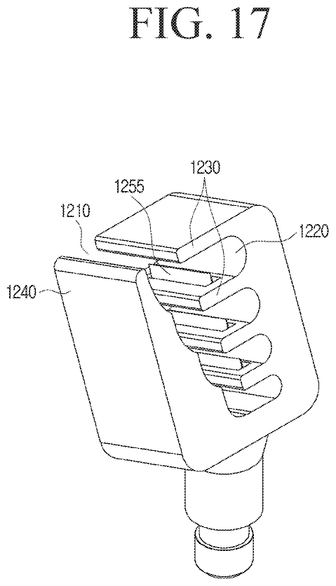

FIG. 17 is a diagram illustrating a holder 1200 including a leaf spring 1255 according to an embodiment of the disclosure.

Referring to FIG. 17, the latch 1250 may include a leaf spring 1255. The leaf spring 1255 is a plate-shaped spring having elasticity, and may be formed of a single plate. The leaf spring 1255 has a structure that may be pressed in the forward direction of the umbrella shaft of the input path 1230, and may prevent separation of the umbrella shaft due to vibration generated when the driving apparatus 1120 is driven.

When the holder 1200 includes a plurality of fixing grooves 1220, the leaf spring 1255 formed of one single plate may protrude from the lower end of the upper input path 1230 and the upper end of the lower input path 1230 to prevent detachment of the umbrella shaft.

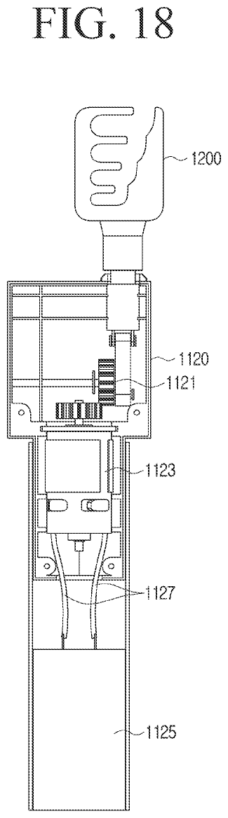

FIG. 18 is a diagram illustrating a driving apparatus 1120 according to an embodiment of the disclosure.

Referring to FIG. 18, the driving apparatus 1120 may be applied in various ways to apply vibration to the holder 1200, and may include a battery 1125, an electric wire 1127, a motor 1123, and a gear 1121.

The battery 1125 may supply power to the motor 1123 through the electric wire 1127. Since the device for removing rainwater from an umbrella 100 is mainly disposed at the entrance of a building or the like at the time of rain, a cable connection for receiving external power by adopting the format of the battery 1125 is not required, the fluidity of the arrangement position is secured, and the risk of electric shock when exposed to rainwater may be reduced.

The motor 1123 may generate vibration in the holder 1200 attached to the upper portion using the gear 1121. A vibration displacement and a vibration period of the holder 1200 may be determined by a coupling method and a shape of the gear 1121.

Since rainwater is removed with inertia force due to the vibration of the holder 1200, a method of rapidly generating vibration on a small displacement may be advantageous to quickly remove rainwater. Therefore, the vibration displacement of the holder 1200 may be 1 cm to 2 cm in consideration of the rainwater removal effect of the umbrella and the safety of the user.

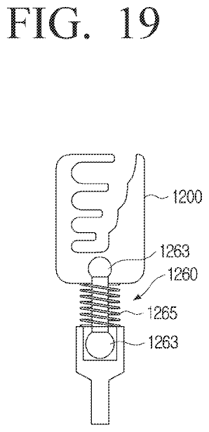

FIG. 19 is a diagram illustrating a coupling member 1260 of a holder 1200 according to an embodiment of the disclosure.

Referring to FIG. 19, the holder 1200 may include a coupling member 1260, and the coupling member 1260 may include a ball joint 1263 and a spring 1265. The coupling member 1260 may include a ball joint 1263 and a spring 1265, and the holder 1200 may have flexibility and prevent vibration loss.

In detail, the rotation shaft is formed in the ball joint 1263 of the lower portion, so that the holder 1200 may secure flexibility in a predetermined range in the left and right direction. In addition, the spring 1265 may connect the holder 1200 and the driving apparatus 1120 together with the ball joint 1263, and minimize energy loss when the vibration of the driving apparatus 1120 is transmitted to the holder 1200.

Therefore, since the coupling position and the coupling angle of the umbrella shaft may be different depending on users, the coupling between the holder 1200 and the umbrella shaft may be easier due to the flexibility of the holder 1200.

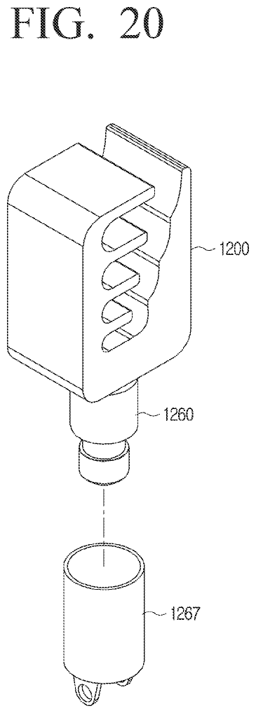

FIG. 20 is a diagram illustrating a detachable holder 1200 according to an embodiment of the disclosure.

Referring to FIG. 20, the holder 1200 may include an inlet 1267 at a lower end of the coupling member 1260 so that the holder 1200 may be detachably connected to the holder 1200.

The holder 1200 may be damaged or worn by vibration or may need to change the shape of the holder 1200 according to circumstances. The holder 1200 may include an inlet 1267 so that the holder 1200 may be changed by the user, the repair of the holder 1200 may be facilitated, and the user may reduce maintenance costs.

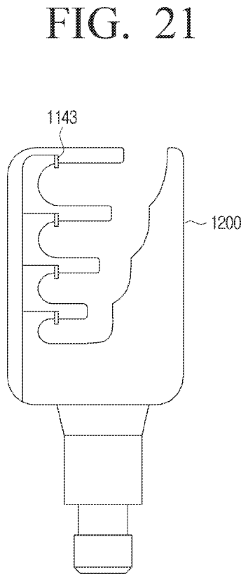

FIG. 21 is a diagram illustrating a fixing groove switch 1143 of a holder 1200 according to an embodiment of the disclosure.

Referring to FIG. 21, a fixing groove switch 1143 may be formed between the fixing groove 1220 and the opening 1210 to selectively apply the power to the processor 130 according to whether the holder 1200 is mounted on the umbrella shaft.

The fixing groove switch 1143 may be formed in each of the fixing grooves 1220 or the input path 1230, and may be switched by the umbrella shaft when the umbrella shaft is introduced into the fixing groove 1220 through the input path 1230, and may apply power to the processor 130. Since the fixing groove switch 1143 automatically applies power to the processor 130 and drives the driving apparatus 1120 without any operation other than the basic operation for fixing the umbrella shaft, thereby increasing user convenience.

The fixing groove switch 1143 may allow the processor 130 to recognize the fixing groove 1220 in which the umbrella shaft is fixed among the plurality of fixing grooves 1220, and may differently adjust the vibration method according to the fixing groove 1220 in which the umbrella shaft is fixed.

In the embodiment in which the holder 1200 includes the latch 1250, the movement of the latch 1250 is fixed according to the signal of the fixing groove switch 1143 to which the umbrella shaft is fixed, thereby effectively preventing the detachment of the umbrella shaft.

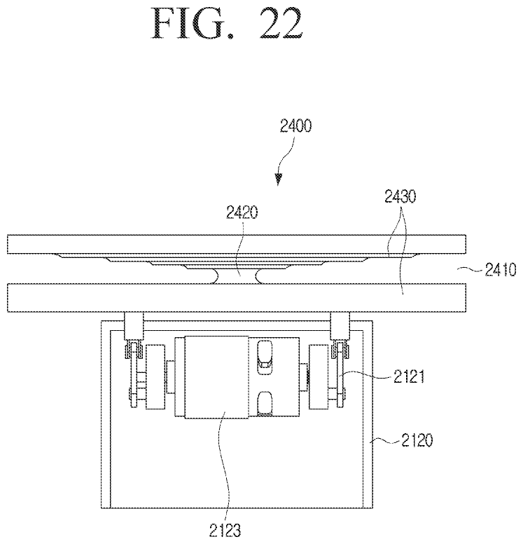

FIG. 22 is a diagram illustrating a holder 2400 according to an embodiment of the disclosure.

Referring to FIG. 22, the holder 2400 may include an opening 2410, a fixing pillar 2420, a plurality of support plates 2430, and may be made of a light material such as an aluminum alloy.

The opening 2410 is an open space between a plurality of support plates 2430 and is an entrance path through which the umbrella shaft enters the holder 2400. The umbrella shaft input through the opening 2410 may move toward the fixing pillar 2420.

The shape and direction of the opening 2410 may vary depending on the arrangement of the plurality of support plates 2430 and the individual shapes, and as shown in FIG. 22, the opening 2410 may have a structure opened to the front surface of the side surface of the holder 2400. Accordingly, the opening 2410 may accommodate the umbrella shaft on the front surface of 360 degrees, and convenience may be increased in the position and angle at which the user inputs the umbrella shaft. The user may put the umbrella shaft to the device for removing rainwater from an umbrella 00 at any location, without requiring the user to move in a direction toward the opening 2410 to input the umbrella shaft.

The fixing pillar 2420 may interconnect and support the plurality of support plates 2430. The umbrella shaft may be fixed, and the shape of the general umbrella shaft is circular, so the fixing pillar 2420 may be formed in the shape of a pillar having a concave central portion.

The plurality of support plates 2430 may be spaced apart from each other and serve to fix the umbrella shaft input to the holder 2400 through the opening 2410. An individual structure of the plurality of support plates 2430 may have a circular or polygonal shape, and an inner surface facing the fixing pillar 2420 and an outer surface opposite to the inner surface may be formed differently.

As the plurality of support plates 2430 are closer to the fixing pillar 2420 from the outside of the holder 2400, the width of the support plate 2430 may decrease. As the spaced width disposed between the plurality of support plates 2430 decreases, the umbrella shaft may be fixed to the plurality of support plates 2430 without reaching the fixing pillar 2420.

As illustrated in FIG. 2, the plurality of support plates 2430 may have different widths between the plurality of support plates 2430 by the structure of the inner surface of the support plate 2330 positioned at the upper end.

In detail, when the plurality of support plates 2430 are circular, the fixing pillar 2420 may be located at the center of the circle, and the width between the plurality of support plates 2430 may be increased at a predetermined radius interval so that the holder 2400 may contain and fix various sizes of umbrella shafts.

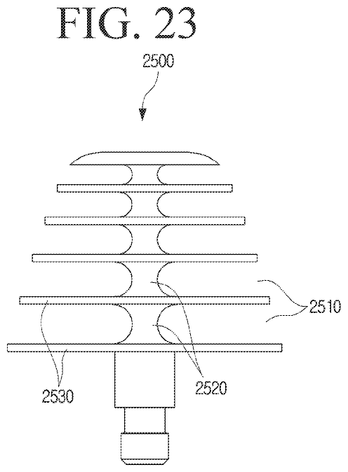

FIG. 23 is a diagram illustrating a holder 2500 according to an embodiment of the disclosure.

Referring to FIG. 23, the plurality of support plates 2530 may include three or more support plates and spacing between a plurality of support plates 2530 may be different from each other.

As the spacing between the plurality of support plates 2530 is different from each other, the size of the umbrella shaft that may be introduced may vary, and thus the umbrella shaft may be inserted to the appropriate opening 2510 according to the size of the umbrella shaft.

The plurality of support plates may be disposed from the upper portion to the lower portion, having different areas.

In detail, the area may gradually increase from the uppermost support plate to the lowermost support plate. The holder 2500 of which the plurality of support plates 2530 are circular may have a structure as shown in FIG. 3.

Accordingly, after putting the umbrella shaft on a specific support plate of the holder 2500, if the umbrella shaft is larger than the opening 2510 between the corresponding support plates, the user may push the umbrella shaft toward the outside direction of the holder 2500 so that the umbrella shaft naturally moves downward and moves to the support plate at the lower end. In this way, the user may fix the umbrella shaft to the holder 2500 in an intuitive and easy manner.

As the plurality of support plates 2530 are disposed downward from the upper portion of the holder 2500, the umbrella shaft may be fixed in the vertical direction, and the driving apparatus may effectively remove the umbrella rainwater by generating vibration in the vertical direction in the holder.

Although not shown in the drawing, the holders 2400 and 2500 according to an embodiment may include a latch, and the latch may prevent separation of the umbrella shaft fixed to the holders 2400 and 2500.

The latch may have a structure and shape that can be gently pressed in the direction in which the umbrella shaft is inserted through the openings 2410 and 2510.

One or more latches may be disposed on one support plate. In addition, the latch may be fixed when the driving apparatus is driven by the processor 130 to reliably prevent separation of the umbrella shaft.

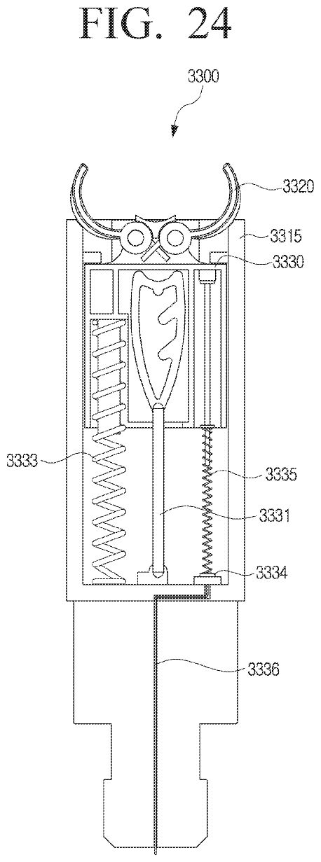

FIG. 24 is a diagram illustrating a holder 3300 according to an embodiment of the disclosure.

Referring to FIG. 24, the holder 3300 may include a case 3315, a fixing pin 3320, and a support 3330, and may be made of a light material like aluminum alloy.

The case 3315 is formed with an opening 3310, may protect the components of the holder 3300, and may prevent failures and accidents due to inflow of foreign substances from the outside.

The opening 3310 is a space opened to one side of a case and may have a different shape and movement direction, and may have a structure opened to the upper surface of the holder 3300 as shown in FIG. 24. In addition, the opening 3310 may be opened toward an upper side to which the stand 110 is extended, and or the stand 110 is inclined, the opening 3310 may be opened to face the upper side of the support 3115.

The fixing pin 3320 may be disposed in the opening 3310 to fix the umbrella shaft. Specifically, the fixing pin 3320 may pass through the opening 3310 to be exposed to the outside of the case 3315, fix the external umbrella shaft, and transmit vibration.

The fixing pin 3320 may be movable, and may be supported by the support 3330 to move up and down or left and right.

The support 3330 may support the fixing pin 3320, may be coupled to or connected to the components of the holder 3300, which will be described later, and may help fix the umbrella shaft by moving the fixing pin 3320 from the holder 3300.

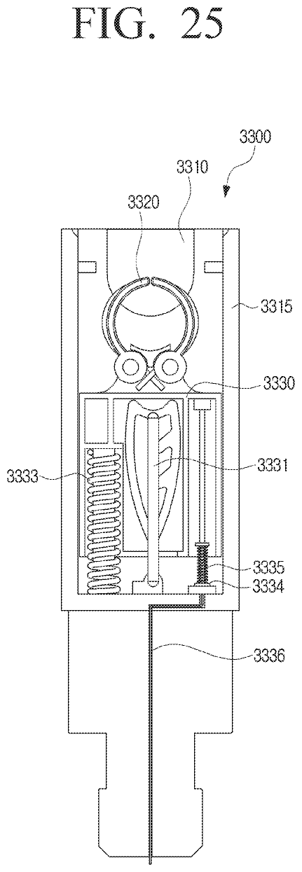

FIG. 25 is a diagram illustrating a holder 3300 according to an embodiment of the disclosure. To be specific, the fixing pin 3320 of the holder 3300 of FIG. 24 moves downward.

Referring to FIG. 25, the holder 3300 may include a compression spring 3333, a switch 3334, a detection spring 3335, and a guide rod 3331.

The compression spring 3333 may be compressed by the movement of the fixing pin 3320. The compression spring 3333 may be connected to the support 3330, and may be directly connected to the fixing pin 3320. The compression spring 3333 may be compressed when the fixing pin 3320 of the holder 3300 receives pressure and moves to the lower end, and may convert the energy received by the fixing pin 3320 into elastic energy and store the elastic energy.

The compression spring 3333 may push the fixing pin 3320 to the upper end and move the fixing pin 3320 to the outside of the opening 3310 when the pressure is removed or the fixing pin 3320 is unwound by the guide rod 3331 to be described later.

The detection spring 3335 may be disposed on the side surface of the compression spring, but there is no restriction on the position, and as the fixing pin 3320 moves to the lower end, the detection spring 3335 may be compressed or extended.

The switch 3334 may be switched by compression of the detection spring 3335 and may provide a detection result to the processor 130.

Referring to FIGS. 2 and 3, the detection spring 3335 and the switch 3334 are attached to each other, and the switch 3334 may be switched according to the degree of movement of the fixing pin 3320 or the transferred pressure. Alternatively, unlike FIG. 2, the detection spring 3335 may be spaced apart from the switch 3334, and the fixing pin 3320 may move to the lower end and may transfer pressure to the switch 3334 to switch the switch 3334.

The device for removing rainwater from an umbrella 100 may fix the umbrella shaft by the fixing pin 3320 and automatically drive the driving apparatus 3120 by fixing or pressing the umbrella shaft to the holder 3300 without separate manipulation by the detection spring 3335 and the switch 3334.

As a result, the device for removing rainwater from an umbrella 100 may automatically apply power to the processor 3130 to drive the driving apparatus 120 without any other manipulation in addition to the basic operation of fixing the user's umbrella shaft, thereby increasing user convenience.

The switch 3334 may recognize the weight of the umbrella or the size of the umbrella shaft according to the pressure that the detection spring 3335 presses, and thus the vibration method may be adjusted differently.

The guide rod 3331 may be connected to the support 3330 to fix the support 3330. Alternatively, the fixing pin 3320 may be fixed by being directly connected to the fixing pin 3320.

A method of fixing the support 3330 and the fixing pin 3320 to a specific position by the guide rod 3331 may be entirely automatic by the processor 3130 or by using the structure of the support 3330 and the compression spring 3333 as illustrated in FIGS. 2 and 3.

In the fixing method, the support 3330 may include a groove to which the guide rod may be fixed, and the guide rod 3331 may fix the support 3330 at a specific position.

The guide rod 3331 may move from the lower end of the support 3330 to the groove formed at the top as the fixing pin 3320 moves to the bottom, and may be fixed at the corresponding position. The fixing pin 3320 is pushed to the bottom by a weak pressure, the guide rod leaves the upper groove, the fixing is released, and the fixing pin 3320 may move to the top by the compression spring 3333.

The guide rod 3331 may fix the support at a preset position according to the degree of pressure that the fixing pin 3320 receives.

In detail, when the fixing pin 3320 moves to the lower end with a strong pressure, the fixing pin 3320 may move to the lowermost portion without being inclined to a specific position where the compression spring 3333 and the detection spring 3335 are disposed, and the guide rod 3331 may be fixed the uppermost groove of the support 3330.

On the other hand, when the fixing pin 3320 moves to the lower end with a weak pressure, it is inclined toward the relatively weak elastic force of the compression spring 3333 or the detection spring 3335, and the guide rod 3331 is also moved to the groove formed in the middle. The fixing pin 3320 does not move to the lowest end, and may be fixed in the middle end groove. Similarly, when the fixing pin 3320 is pushed to the bottom with a weak pressure, the guide rod is released from the middle end groove and fixing is released, and the fixing pin 3320 may be moved to the top by the compression spring 3333.

The fixing pin 3320 may include a clamp member having a clearance as shown in FIGS. 24 and 25, and the clamp member may be opened and closed in response to the vertical movement of the fixing pin 3320.

The clamp member with a clearance may be in an open state when the fixing pin 3320 is located at the top, and may be in a closed state as the fixing pin 3320 moves to the bottom. Therefore, when the umbrella shaft is inserted in a state in which the fixing pin 3320 is open at the top, the fixing pin 3320 moves to the bottom and closes to fix the umbrella shaft.

The opening 3310 may be opened by extending from the upper end of the case 3315 to an upper portion of the side of the case 3315 within the displacement of the fixing pin 3320.

In detail, the case 3315 may be opened in the moving direction of the umbrella in which the fixing pin 3320 moves up and down with respect to the front and rear, which is the direction in which the umbrella placed on the fixing pin 3320 proceeds.

The opening 3310 is opened within the movement range of the lowermost end of the fixing pin 3320, and when the umbrella shaft is smaller than the width of the fixing pin 3320, the upper side of the umbrella may be fixed to the fixing pin 3320, and the lower side of the umbrella may be fixed to the lower end of the extended opening 3310.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. A device for removing rainwater from an umbrella comprising:
a support;
a stand extending upward from the support;
a holder for fixing an umbrella shaft;
a driving apparatus coupled to the stand and for vibrating the holder;
a processor for controlling vibration generated by the driving apparatus,
wherein the holder comprises:
an opening, a fixing groove for fixing the umbrella shaft, and a support member for supporting the umbrella shaft from the opening to the fixing groove,
wherein width of the opening decreases at a predetermined interval in the fixing groove direction from an outside of the holder, and
wherein the opening is open in a linear direction to the fixing groove such that the umbrella shaft is fixed to the support member or the fixing groove matching the width of the umbrella shaft.

2. The device of claim 1, wherein the opening is opened toward a side of the holder,
wherein the fixing groove is formed below the opening, and
wherein the support member has a direction of being inclined in a downward direction of the holder.

3. The device of claim 1, wherein the opening is opened toward an upper portion of the holder, and
wherein the driving apparatus generates vibration of left and right directions to the holder.

4. The device of claim 1, wherein the stand is inclined toward a front direction from the stand.

5. The device of claim 4, further comprising:
a coupling member disposed between the holder and the driving apparatus,
wherein the coupling member supports the holder by a holder spring.

6. The device of claim 1, wherein the holder comprises a plurality of openings and the fixing grooves, and
wherein the plurality of fixing grooves have different widths.

7. The device of claim 1, further comprising:
a switch disposed between the fixing groove and the opening,
wherein the switch selectively applies power to a processor according to whether an umbrella shaft is mounted to the holder.

8. The device of claim 1, further comprising:
a first detection sensor for detecting a canopy of the umbrella shaft coupled to the holder.

9. The device of claim 8, further comprising:
a second detection sensor located below the first detection sensor and for detecting distance from the canopy of the umbrella shaft coupled to the holder.

10. The device of claim 1, wherein the support comprises an anti-slip member attached to a bottom surface of the support.

11. The device of claim 1, further comprising:
a castor coupled to the support.

12. The device of claim 1, further comprising:
a display for displaying an operation state of the driving apparatus.

13. The device of claim 1, comprising:
a switch for selectively applying power to the processor,
wherein the switch has a shape of a pedal, applies power to the processor based on the pedal being pressed, and cuts off power to the processor based on the pedal being unpressed.

14. The device of claim 1, further comprising:
a sealing for surrounding an outer part of the holder.
